(19) United States
(12) Patent Application Publication
(10) Pub. No.: US 2014/0366016 A1
(43) Pub. Date: Dec. 11, 2014

(54) Software Installation Method, Device and System

(71) Applicant: TENCENT TECHNOLOGY (SHENZHEN) COMPANY LIMITED, Shenzhen (CN)

(72) Inventors: Qing Wang, Shenzhen (CN); Zhanghu Luo, Shenzhen (CN); Zefeng Huang, Shenzhen (CN); Haoran Guo, Shenzhen (CN); Quanhao Xiao, Shenzhen (CN); Yixia Yuan, Shenzhen (CN); Jiashun Song, Shenzhen (CN); Pengtao Li, Shenzhen (CN); Yunfeng Dai, Shenzhen (CN)

(21) Appl. No.: 14/455,998

(22) Filed: Aug. 11, 2014

Related U.S. Application Data
(63) Continuation of application No. PCT/CN2013/000218, filed on Mar. 1, 2013.

(51) Int. Cl. G06F 9/445

(52) U.S. Cl. CPC G06F 8/61
USPC 717/178

(57) ABSTRACT

A software installation method, device and system are disclosed, which relate to computer technology. In the method, when a user requests software installation on a first mobile terminal, receive information of the user and identification info of the software sent from the first mobile terminal, look up corresponding relationships between user information and software information established in advance, and judge whether the corresponding relationships include the information of the user and the identification info of the corresponding software. If yes, find an installation package corresponding to the identification info of the software, and send the installation package found to the first mobile terminal for installing the software on the first mobile terminal. A server includes: a first receiving module, a judgment module, a lookup module and a sending module. A mobile terminal includes: a sending module, a receiving module, and an installation module.

This application is a continuation of International Application No. PCT/CN2013/000218, filed on Mar. 1, 2013, which claims priority to a Chinese patent application No. 2012100410721 entitled “Software Installation Method, Device and System”, submitted to the State Intellectual Property Office on Feb. 22, 2010, the entire contents of each application are incorporated herein by reference.

### FIELD OF THE INVENTION

The invention relates to computer technology, and more particularly, to a software installation method, device and system.

### BACKGROUND OF THE INVENTION

With the development of the mobile phone market, mobile phones upgrade more frequently, and diversified software can be installed on mobile phones. Currently, when a user is to install software on a mobile phone, he/she usually finds the software needed for installation online one by one, and installs the software on the mobile phone after downloading the software.

In the process of realizing the present invention, the inventor finds the following defects of prior art technologies.

To find installation software one by one takes a lot of time and consumes much data traffic, which may lead to low software installation efficiency. Meanwhile, it cannot be guaranteed that the installed software is virus free. The mobile phone is likely to be infected with virus and has certain risks.

### SUMMARY OF THE INVENTION

In order to improve the software installation efficiency and reduce risks for mobile terminals, embodiments of the invention provide a software installation method, device and system. The technical solution is as follows.

In an aspect, a software installation method includes:

when a user requests software installation on a first mobile terminal, receiving information of the user and identification info of the software sent from the first mobile terminal;

looking up corresponding relationships between user information and software information established in advance, and judging whether the corresponding relationships include the information of the user and the identification info of the corresponding software; and

if yes, confirming that the user has backed up the software information, looking up an installation package corresponding to the identification info of the software, and sending the installation package found to the first mobile terminal for installation of the software.

The method further includes:

before receiving the information of the user and the identification info of the software sent from the first mobile terminal, when the user requests to back up the software, receiving the user information and the identification info of the software; and

establishing a corresponding relationship between the user information and the identification info of the software.

In the method, judging whether the corresponding relationships include the information of the user and the identification info of the corresponding software further includes:

judging whether the corresponding relationships include the information of the user and a configuration file of the corresponding software; and

if yes, sending the configuration file to the first mobile terminal, wherein the configuration file is used to replace a configuration file generated during the installation of the software on the first mobile terminal.

In the method, receiving the information of the user and the identification info of the software sent from the first mobile terminal further includes: receiving personalized information of the user sent from the first mobile terminal; and

looking up the installation package corresponding to the identification info of the software includes:

judging whether the user chooses to install a latest version of the software according to the personalized information of the user;

if yes, looking up the corresponding installation package of the latest version according to the personalized information of the user;

otherwise, looking up version information of a backup of the software corresponding to the information of the user stored in the corresponding relationship, and finding a corresponding installation package according to the version information found.

Or, receiving the information of the user and the identification info of the software sent from the first mobile terminal further includes: receiving personalized information of the user and information of an operating system of the first mobile terminal sent from the first mobile terminal; and

looking up an installation package corresponding to the identification info of the software includes:

according to the personalized information of the user and the information of the operating system of the first mobile terminal, judging whether the user chooses to accept a recommended installation package when there is no installation package matching the operating system of the first mobile terminal;

if yes, looking up an installation package of other software relating to the software that matches the operating system of the first mobile terminal;

otherwise, prompting no installation package of the software matching the operating system of the first mobile terminal, and ending the process.

In another aspect, a software installation method includes:

when a user requests software installation, sending information of the user and identification info of the software to a server, wherein the information of the user and the identification info of the software are used by the server to judge whether the information of the user and the identification info of the corresponding software exist in corresponding relationships between user information and software information established in advance;

when the server confirms that the user has backed up the software information and finds an installation package according to the identification info of the software, receiving the installation package sent by the server; and

installing the software according to the installation package received.

In the method, receiving the installation package sent by the server further includes: receiving a configuration file of the software corresponding to the information of the user sent by the user, wherein the configuration file is backed up by the user and saved in the corresponding relationships by the server; and

installing the software according to the installation package received further includes: replacing a configuration file generated during the installation with the configuration file received.

In the method, sending the information of the user and the identification info of the software further includes: if the user sets personalized information concerning whether to install a latest version of the software, sending the personalized information of the user to the server; and

receiving the installation package sent by the server includes:

when the server determines that the user selects to install the software with the latest version according to the personalized information of the user, receiving the installation package of the latest version corresponding to the identification info of the software sent by the server; and

when the server determines that the user selects to install the software with a backup version according to the personalized information of the user, finding out an installation package according to version information at backup of the software corresponding to the information of the user sent by the server.

In the method, sending the information of the user and the identification info of the software to the server further includes:

if the user sets personalized information concerning whether to accept a recommended installation package when there is no installation package matching a local operating system, sending the personalized information of the user and information of the local operating system to the server; and

receiving the installation package sent by the server includes:

when the sever determines, according to the personalized information of the user and the information of the local operating system, that the user chooses to accept the recommended installation package when there is no installation package matching the operating system, accepting an installation package of other software sent by the server related to the software and matching the operating system.

In another aspect, a server includes:

a first receiving module, used to receive information of a user and identification info of software sent from a first mobile terminal when the user requests to install the software on the first mobile terminal;

a judgment module, used to look up corresponding relationships between user information and software information established in advance, and judge whether the corresponding relationships include the information of the user and the identification info of the corresponding software;

a lookup module, used to determine that the user has backed up the software information when the judgment module determines that the corresponding relationships include the information of the user and the identification info of the corresponding software, and look up an installation package corresponding to the software; and

a sending module, used to send the installation package found by the lookup module to the first mobile terminal, wherein the installation package is used to install the software on the first mobile terminal.

The server further includes:

a second receiving module, used to receive the information of the user and the identification info of the software when the user requests to back up the software; and

an establishment module, used to establish a corresponding relationship between the information of the user and the identification info of the software.

The judgment module is further used to judge whether the corresponding relationships include a configuration file of the software corresponding to the information of the user; and

the sending module is further used to send the configuration file to the first mobile terminal when the judgment module determines that the corresponding relationships include the configuration file of the software corresponding to the information of the user, wherein the configuration file is used to replace a configuration file generated during the installation after the software is installed on the first mobile terminal.

The first receiving module is further used to receive personalized information of the user sent from the first mobile terminal; and

the lookup module includes:

a first judgment unit, used to judge whether the user chooses to install a latest version of the software according to the personalized information of the user;

a first lookup unit, used to look up the installation package with the latest version corresponding to the identification info of the software when the first judgment unit determines that the user chooses to install the latest version of the software; and

a second lookup unit, used to look up version information of the software at backup corresponding to the information of the user within the corresponding relationships when the first judgment unit determines that the user chooses not to install the latest version of the software, and look up an installation package corresponding to the version information found.

The first receiving module is further used to receive the personalized information of the user sent from the first mobile terminal and information of the operating system of the first mobile terminal; and

the lookup module includes:

a second judgment unit, used to judge whether the user chooses to accept the recommended installation package when there is no installation package matching the operating system of the first mobile terminal according to the personalized information of the user and the information of the operating system of the first mobile terminal;

a third lookup unit, used to look up an installation package of other software matching the operating system of the first mobile terminal and relating to the software according to the identification info of the software and the information of the operating system of the first mobile terminal when the second judgment unit determines that the user chooses to accept the recommended installation package when there is no installation package matching the operating system of the first mobile terminal; and

a prompt unit, used to prompt that there is no installation package of the software matching the operating system of the first mobile terminal when the second judgment unit determines that the user chooses not to accept the recommended installation package when there is no installation package matching the operating system of the first mobile terminal, and end the process.

In yet another aspect, a mobile terminal includes:

a sending module, used to send information of a user and identification info of software to a server when the user requests to install the software, to enable the server to judge whether pre-established corresponding relationships between user information and software information include the information of the user and the identification info of the software;

a receiving module, used to receive an installation package sent from the server when the server determines that the user has backed up the information of the software and found corresponding installation package according to the identification info of the software; and

an installation module, used to install the software according to the installation package received by the receiving module.

The receiving module is further used to receive a configuration file of the software corresponding to the information of the user sent by the server, wherein the configuration file is backed up by the user and saved in the corresponding relationships by the server;

the mobile terminal further includes: a replacement module, used to replace a configuration file generated in the installation process with the configuration file received by the receiving module; and

the sending module is further used to send personalized information of the user to the server if the user has set up the personalized information concerning whether to install the latest version of the software.

The sending module is further used to send the personalized information of the user to the server if the user has set up the personalized information concerning whether to install the latest version of the software; and

the receiving module includes:

a first receiving unit, used to receive the installation package of the latest version corresponding to the identification info of the software sent by the server when the server determines that the user chooses to install the latest version of the software according to the personalized information of the user;

a second receiving unit, used to receive the corresponding installation package found according to version information of the software at backup sent by the server when the server determines that the user chooses to install the backup version of the software according to the personalized information of the user.

The sending module is further used to send the personalized information and information of the local operating system to the server if the user has set up the personalized information concerning whether to accept the recommended installation package when there is no installation package matching the local operating system; and

the receiving module is used to receive the installation package of other software related to the software that is sent by the server and matches the operating system when the server determines according to the personalized information of the user and the information of the operating system that the user chooses to accept the recommended installation package when there is no installation package matching the operating system.

In yet another aspect, a software installation system includes: the server as described above, and the mobile terminal as described above.

The technical solution provided by the embodiments of the invention has the following benefits.

When a user requests to install software on a mobile terminal, the user information and the software identification info sent from the mobile terminal is received. When it is determined that the user has backed up information of the software according to pre-established corresponding relationships between user information and software information, look up an installation package corresponding to the identification info of the software, and send it to the mobile terminal to allow the mobile terminal to install the software according to the installation package. This saves the time and data traffic used in looking for installation software on a one-by-one mode, improves the software installation efficiency. Also, the risk associated with software installation on mobile terminals may be reduced because the installation package found is safe and virus free.

Further, a configuration file backed up in advance and the installation package found are sent to the mobile terminal, and the mobile terminal may configure the software according to the configuration file to retain original using habits of the user and greatly improve user experience. Besides, software can be installed according to personalized information of the user and in different situations according to different user settings. The technical solution has more flexible application and strong practicability, and may improve user satisfaction.

### BRIEF DESCRIPTION OF DRAWINGS

In order to illustrate the technical solution in the embodiments of the invention more clearly, attached drawings used in description of the embodiments are introduced briefly below. Obviously, the attached drawings in the description are only some of the embodiments of the invention. Those skilled in the art can obtain other drawings according to the attached drawings below without any creative work.

FIG. 1 is a flowchart of a method for installing software provided in an embodiment.

FIG. 2 is a flowchart of another software installation method provided in an embodiment.

FIG. 3 is a flowchart of a software installation method provided in an embodiment.

FIG. 4 is a flowchart of a software installation method provided in an embodiment.

FIG. 5 is a flowchart of a software installation method provided in an embodiment.

FIG. 6 is a structural diagram of a server provided in an embodiment.

FIG. 7 is a structural diagram of another server provided in an embodiment.

FIG. 8 is a structural diagram of a mobile terminal provided in an embodiment.

FIG. 9 is a structural diagram of another mobile terminal provided in an embodiment.

FIG. 10 is a structural diagram of a system for installing software provided in an embodiment.

### DETAILED DESCRIPTION OF THE INVENTION

In order to better clarify the objectives, technical solutions and advantages of the invention, detailed description is given below on embodiments of the invention in conjunction with the attached drawings.

The embodiments of the invention involve software installation technologies, especially software installation technologies on mobile terminals. The mobile terminals are wireless communication terminals such as a mobile phone and a tablet computer. The software may be software of any type that can be installed on a mobile terminal, such as word, QQ, msn, etc. Besides, installation of software on the mobile terminal in the embodiments is done by backing up the software information on a server, and looking up corresponding installation package and distributing the package to the mobile terminal by the server. When a user backs up software on one mobile terminal and then installs the software on another mobile terminal, the software installation is done across mobile terminals. The invention does not limit the specific application scenario. The server refers to an equipment used to back up the software information and store software installation packages of various versions. The server can backup diversified software information according to a user request, establish and maintain the corresponding relationship between user information and software information, store various types of software and installation packages of various versions so as to distribute them to mobile terminals for software installation.

Refer to FIG. 1, the embodiment provides a software installation method. The detailed procedure of the method is as follows.

101: Receive user information and identification info of a piece of software sent from a first mobile terminal when a user requests software installation on the first mobile terminal.

102: Look up the corresponding relationship between user information and software information established in advance, and judge whether the corresponding relationship includes information of the user and identification info of the corresponding software.

103: If yes, determine that the user has backed up information of the software, look up corresponding installation packages according to the identification info of the software, and send the packages found to the first mobile terminal for software installation.

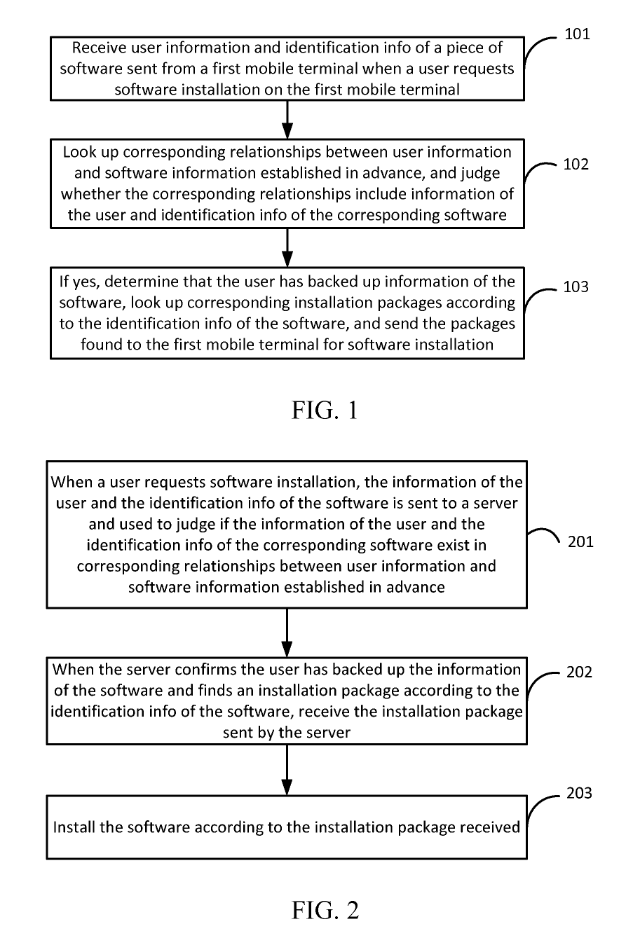

Refer to FIG. 2, the embodiment provides another software installation method, which includes the following.

201: When a user requests software installation, the information of the user and the identification info of the software is sent to a server and used to judge if the information of the user and the corresponding identification info of the software exist in corresponding relationships between user information and software information established in advance.

202: When the server confirms the user has backed up the information of the software and finds an installation package according to the identification info of the software, receive the installation package sent by the server.

203: Install the software according to the installation package received.

In the method provided by the embodiment, when a user requests to install software on a mobile terminal, the server receives the information of the user and the identification info of the software sent from the mobile terminal, determines that the user has backed up the information of the software according to the pre-established corresponding relationships of user information and software information, looks up the installation package corresponding to the identification info of the software, and sends it to the mobile terminal. The mobile terminal installs the software according to the installation package. It saves the time and data traffic used in looking for installation software on one-by-one basis, improves the software installation efficiency, and reduces the risk associated with software installation of mobile terminals because the installation package found is safe and virus free.

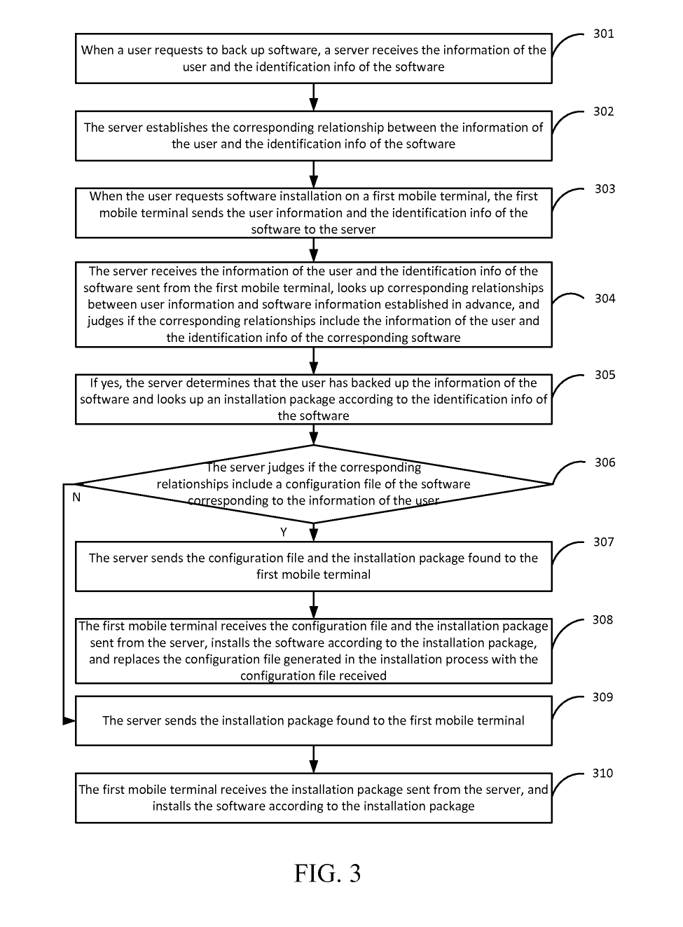

In order to explain the methods provided in the embodiments more specifically, embodiments illustrated in FIGS. 3, 4 and 5 will give more detailed description on methods provided in the embodiments below.

Refer to FIG. 3, the embodiment provides a software installation method. A mobile terminal installs software according to installation packages and configuration files sent from a server. The detailed procedure of the method is as follows.

301: When a user requests to back up software, receive the information of the user and the identification info of the software.

The identification info of the software refers to information used to uniquely identify software, including but not limited to a unique identifier (UID), a name, a publisher and a certificate of the software. The information of the user refers to identity information of the user used by the server to authenticate the user identity, including but not limited to a user name and password. When the user requests software installation, the server will authenticate the user according to the user information. If the authentication is passed, execute the installation procedure of the software; otherwise, the procedure ends.

302: The server establishes the corresponding relationship between the information of the user and the identification info of the software.

The server backs up the software by establishing the corresponding relationship between the information of the user and the identification info of the software and storing the corresponding relationship, so that the server can determine according to the corresponding relationship if the user has backed up the software when the user requests to install the software.

303: When a user requests software installation on a first mobile terminal, receive the user information and the identification info of the software sent from the first mobile terminal.

In blocks 301 and 302 of the embodiment, the user backs up the software via the first mobile terminal or other mobile terminals, e.g., the second mobile terminal. The invention has no restriction on this.

For example, an application scenario is that a user backs up a piece of software on mobile terminal A. When the software cannot be used due to exception later on, the software can be reinstalled (or restored) on mobile terminal A according to the backup. Another application scenario is that a user backs up a piece of software on mobile terminal A and wants to install the same software on mobile terminal B later on, then the software can be installed on mobile terminal B according to the backup.

304: When the server receives the information of the user and the identification info of the software sent from the first mobile terminal, it looks up corresponding relationships between user information and software information established in advance, and judges if the corresponding relationships include the information of the user and the identification info of the corresponding software. If yes, execute block 305; if no, the procedure ends or prompts installation failure due to no backup and then ends.

Specifically, the server can authenticate the information of the user first. If the authentication is passed, then look up the corresponding relationships and judge if the corresponding relationships include the information of the user and the identification info of the corresponding software.

305: The server determines that the user has backed up the information of the software and looks up an installation package according to the identification info of the software.

The installation package in this embodiment is used for software installation. A mobile terminal can execute software installation according to the installation package.

Specifically, the resource library of the server stores various versions of software, and each piece of software has installation packages of several versions. Therefore, installation packages of each version can be obtained according to the identification info of the software.

306: The server judges if the corresponding relationships include a configuration file of the software corresponding to the information of the user. If yes, execute block 307; otherwise, execute block 309.

In the embodiment, the configuration file includes some using habit information of the user on the software, including but not limited to a software bookmark, a font size and a background image, which may not be restricted by the invention. The configuration file is backed up on the server together with the identification info of the software during software backup.

Specifically, when a user backs up the information of the software through a mobile terminal, he can set up whether to back up the personalized information of the configuration file. If the user selects yes, the configuration file of the software will also be sent to the server together with the user information and the identification info of the software for backup. If the user selects no, only the user information and the identification info of the software will be sent to the server.

307: The server sends the configuration file and the installation package found to the first mobile terminal, and then executes block 308.

308: The first mobile terminal receives the configuration file and the installation package sent from the server, installs the software according to the installation package, and replaces the configuration file generated in the installation process with the configuration file received. Then, the procedure ends.

Upon receiving the installation package sent from the server, the first mobile terminal can install the software, automatically generate the configuration file in the software installation process, and save the file in a fixed path. When the first mobile terminal receives the configuration file sent from the server, it can replace the configuration file automatically generated with the configuration file received. Since the configuration file includes using habit information of the user, original using habits can be retained after software installation to achieve the same experience with the software at backup.

309: The server sends the installation package found to the first mobile terminal, and then executes block 310.

310: The first mobile terminal receives the installation package sent from the server, and installs the software according to the installation package. Then, the procedure ends.

In the method provided by the embodiment, when a user requests to install software on a mobile terminal, the server receives the user information and the identification info of the software sent from the mobile terminal, determines that the user has backed up the information of the software according to the pre-established corresponding relationships of user information and software information, looks up installation packages corresponding to the identification info of the software, and sends them to the mobile terminal. The mobile terminal installs the software according to the installation packages. It saves the time and data traffic used in looking for installation software on one-by-one basis, improves the software installation efficiency, and reduces the risk associated with software installation of mobile terminals because the installation packages found are safe and virus free.

Further, the server sends the configuration file backed up in advance and the installation packages found to the mobile terminal, and the mobile terminal configures the software according to the configuration file to retain original using habits of the user, which may greatly improve user experience.

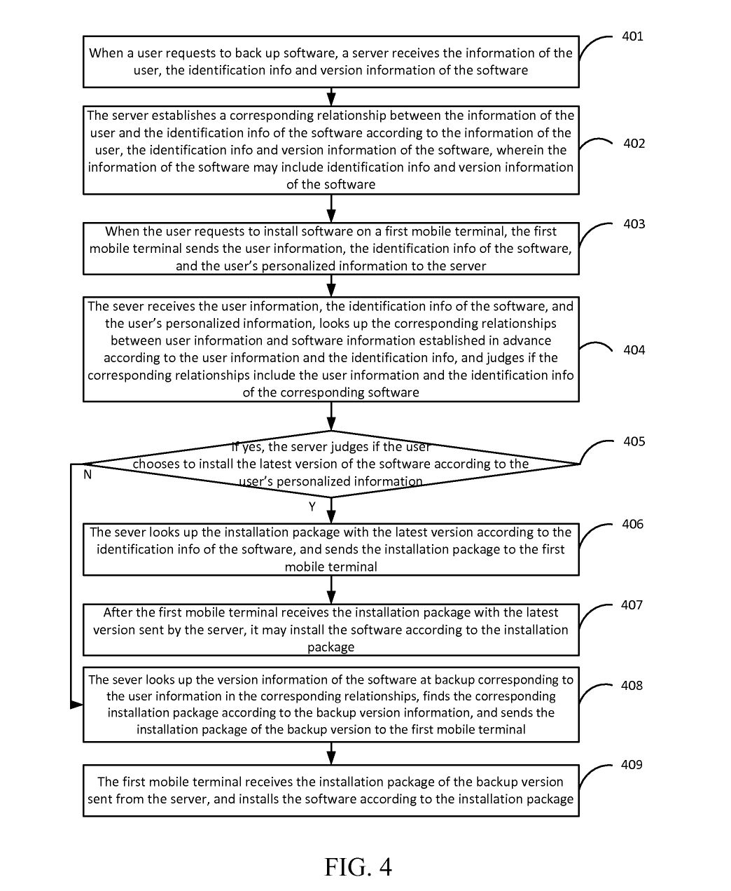

Refer to FIG. 4, the embodiment provides a software installation method. A server retrieves corresponding installation package according to the personalized information set by a user of whether to install the software of the latest version, so as to allow the mobile terminal to install the software with corresponding version. The specific procedure of the method is as follows.

401: When the user requests to back up the software, the server receives the information of the user and the identification info of the software.

The identification info of the software refers to information used to uniquely identify software, while the information of the user refers to identity information of the user used by the server to authenticate the user identity. No additional description is made here because it is the same as the description illustrated in FIG. 3.

The version information of the software is used to identify software version. Specifically, it can be a version number of the software, e.g., v1, v2, v2011 or v2012, etc., which is not restricted by the invention.

402: The server establishes a corresponding relationship between the information of the user and the identification info of the software according to the information of the user, the identification info and version information of the software. The information of the software may include identification info and version information of the software.

403: When the user requests to install software on a first mobile terminal, the first mobile terminal sends the user information, the identification info of the software, and the user's personalized information to the server.

The user's personalized information refers to personalized settings made by the user for software installation. The user can perform the setup according to settings provided by a mobile terminal, where there can be one or more settings and no restriction is made by the invention. For example, the mobile terminal may provide a setting of “whether to install the latest version of software”. If the user chooses yes, the server may find the latest version of an installation package and send it to the mobile terminal. If the user selects no, the server may find the backup version of the installation package and send it to the mobile terminal. Alternatively, the mobile terminal may provide a setting of “whether to accept a recommended installation package when there is no installation package matching the operating system of the mobile terminal”. If the user chooses yes, the server will recommend software with similar functions according to the operating system of the mobile terminal when there is no installation package matching the operating system of the mobile terminal, and send the recommended installation package to the mobile terminal. If the user selects no, the server will not send any installation package to the mobile terminal when there is no installation package matching the operating system of the mobile terminal.

Besides, if the first mobile terminal does not send the user's personalized information, the server will obtain default personalized information. Specifically, the default personalized information can include but not limit to: not to install the latest version of the software, or not to accept the recommended installation package when there is no installation package matching the operating system of the mobile terminal. The invention has no limitation on the default personalized information.

In this embodiment, the user's personalized information sent by the first mobile terminal is a user's setting of whether to install the software with the latest version. Explanation is given below as an example.

In the embodiment, the user backs up the software in blocks 401 and 402 through the first mobile terminal or other mobile terminals, e.g., a second mobile terminal, and the invention has no limitation on the mobile terminal.

404: The sever receives the user information, the identification info of the software, and the user's personalized information sent by the first mobile terminal, looks up the corresponding relationships between user information and software information established in advance according to the user information and the identification info, and judges if the corresponding relationships include the user information and the identification info of the corresponding software. If yes, execute block 405; otherwise, the procedure ends, or prompt the user that the installation fails due to lack of backup and then the procedure ends.

Specifically, the server can authenticate the user information first. If the authentication is passed, look up the corresponding relationships to judge whether there are the user information and the identification info of the corresponding software in the corresponding relationships.

405: When the server determines that the user has backed up the information of the software, judge if the user chooses to install the latest version of the software according to the user's personalized information. If yes, execute block 406; otherwise, execute block 408.

406: The sever looks up the installation package with the latest version according to the identification info of the software, sends the installation package to the first mobile terminal, and then executes block 407.

407: After the first mobile terminal receives the installation package with the latest version sent by the server, it may install the software according to the installation package. Then, the procedure ends.

408: The server looks up the version information of the software at backup corresponding to the user in the corresponding relationships, finds the corresponding installation package according to the backup version information, sends the installation package of the backup version to the first mobile terminal, and then executes block 409.

The resource library of the server stores various versions of software, and each piece of software has installation packages of several versions. Therefore, installation packages of each version can be obtained according to identification info of the software. Look up corresponding installation packages according to the backup version information of the software, and then send the installation packages to the first mobile terminal.

409: The first mobile terminal receives the installation packages of the backup version sent from the server, and installs the software according to the installation packages. Then, the procedure ends.

Further, the method provided by this embodiment above can also be applied in combination with the method provided in the embodiment illustrated in FIG. 3. The server sends the configuration file backed up in advance to the mobile terminal, so that the mobile terminal can replace the configuration file generated in the installation process with this configuration file. Since the configuration file includes using habit information of the user, original using habits can be retained after software installation to achieve the same experience with the software at backup. After receiving an installation request, the server will look up the configuration file accordingly, and send the installation packages found together with the configuration file to the mobile terminal. The detailed procedure is the same as the description illustrated in FIG. 3, and will not be described in more details.

In the method provided by the embodiment, when a user requests to install software on a mobile terminal, a server receives the user information and the identification info of the software sent from the mobile terminal, determines that the user has backed up the information of the software according to the pre-established corresponding relationships of user information and software information, looks up installation packages corresponding to the identification info of the software, and sends them to the mobile terminal. The mobile terminal installs the software according to the installation packages. It saves the time and data traffic used in looking for installation software on one-by-one basis, improves the software installation efficiency, and reduces the risk associated with software installation of mobile terminals because the installation packages found are safe and virus free.

Further, the server sends the configuration file backed up in advance and the installation packages found to the mobile terminal, and the mobile terminal configures the software according to the configuration file to retain original using habits of the user and greatly improve user experience. Besides, software can be installed according to the personalized information of the user and in different situations according to different user settings. The technical solution has more flexible application and strong practicability, and may improve user satisfaction.

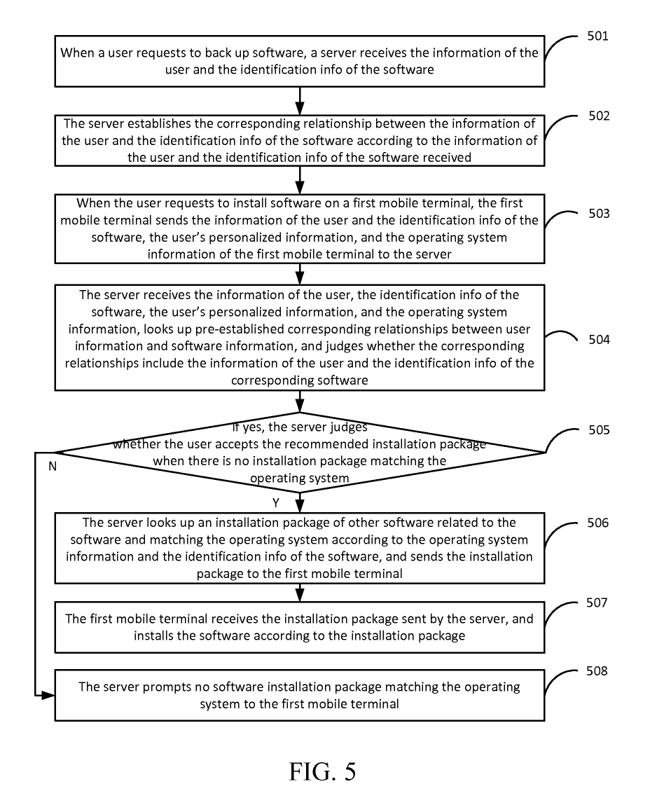

Refer to FIG. 5, this embodiment provides a software installation method. A server obtains a corresponding installation package according to user's personalized information set by a user on whether to accept the installation package recommended by the server when there is no installation package matching the operating system, and sends it to a mobile terminal for software installation. The detailed procedure of the method is as follows.

501: When the user requests to back up the software, the server receives the information of the user and the identification info of the software.

502: The server establishes the corresponding relationship between the information of the user and the identification info of the software according to the information of the user and the identification info of the software received.

503: When the user requests to install software on a first mobile terminal, the first mobile terminal sends the information of the user and the identification info of the software, the user's personalized information, and the operating system information of the first mobile terminal to the server.

Refer to the corresponding description on the embodiment illustrated in FIG. 4 for the user's personalized information. No additional description will be given here.

In this embodiment, the user's personalized information sent by the first mobile terminal is a setting on whether to accept the recommended installation package when there is no installation package matching the operating system of the mobile terminal. Explanation is given hereinafter as an example.

In this embodiment, in blocks 501 and 502, the user backs up the software through the first mobile terminal or other mobile terminals such as a second mobile terminal. The invention has no limitation on mobile terminals.

504: The server receives the information of the user, the identification info of the software, the user's personalized information, and the operating system information of the first mobile terminal sent from the first mobile terminal, looks up pre-established corresponding relationships between user information and software information according to the information of the user and the identification info of the software, and judges whether the corresponding relationships include the information of the user and the identification info of the corresponding software. If yes, execute block 505; otherwise, the procedure ends, or prompts installation failure due to no backup and then ends.

Specifically, the server can authenticate the information of the user first. If the authentication is passed, then look up the corresponding relationships and judge if the corresponding relationships include the information of the user and the identification info of the corresponding software.

505: The server confirms that the user has backed up the information of the software, and judges whether the user accepts the recommended installation package when there is no installation package matching the operating system of the first mobile terminal. If yes, execute block 506; otherwise, execute block 508.

506: The server looks up an installation package of other software related to the software and matching the operating system according to the operating system information and the identification info of the software, sends the installation package to the first mobile terminal, and then executes block 507.

The server can look up other software with similar functions to the software backed up by the user, and recommend it to the first mobile terminal. Specifically, if there are several pieces of other software with similar functions, the server can compare description information of the software, choose the best software according to user voting in the description information, and send the corresponding installation package to the first mobile terminal.

507: The first mobile terminal receives the installation package sent by the server, and installs the software according to the installation package. The procedure ends.

508: The server prompts no software installation package matching the operating system to the first mobile terminal, and the procedure ends.

Further, the method provided by this embodiment above can also be applied in combination with the method provided in FIG. 3. After finding the installation package matching the operating system according to the operating system information of the first mobile terminal, the server sends the configuration file backed up by the user together with the installation package to the mobile terminal, so that the mobile terminal can replace the configuration file generated in the installation process with this configuration file. Since the configuration file includes using habit information of the user, original using habits can be retained after software installation to achieve the same experience with the software at backup. Specifically, the user backs up the configuration file of the software on the server in advance, and the server may look up the configuration file accordingly after receiving an installation request and then send the installation package found to the mobile terminal. The detailed procedure is the same as the description in FIG. 3, and will not be described in more details here.

Or, the method provided by this embodiment above can also be applied in combination with the methods provided in FIGS. 3 and 4. After finding the installation package matching the operating system according to the user's personalized information and the operating system information of the first mobile terminal, the server sends the configuration file backed up by the user together with the installation package matching the operating system to the mobile terminal, so that the mobile terminal can replace the configuration file automatically generated in the installation process with this configuration file after software installation. The detailed procedure is the same as above and will not be described in more details here.

In the method provided by the embodiment, when a user requests to install software on a mobile terminal, a server receives the user information and the identification info of the software sent from the mobile terminal, determines that the user has backed up the information of the software according to pre-established corresponding relationships of user information and software information, looks up installation packages corresponding to the identification info of the software, and sends them to the mobile terminal. The mobile terminal installs the software according to the installation packages. It saves the time and data traffic used in looking for software on one-by-one basis for installation, improves the software installation efficiency, and reduces the risk associated with software installation of mobile terminals because the installation packages found are safe and virus free.

Further, the server sends the configuration file backed up in advance and the installation packages found to the mobile terminal, and the mobile terminal configures the software according to the configuration file to retain original using habits of the user and to greatly improve user experience. Besides, software can be installed according to the personalized information of the user and in different situations according to different user settings. The technical solution has more flexible application and strong practicability, and improves user satisfaction.

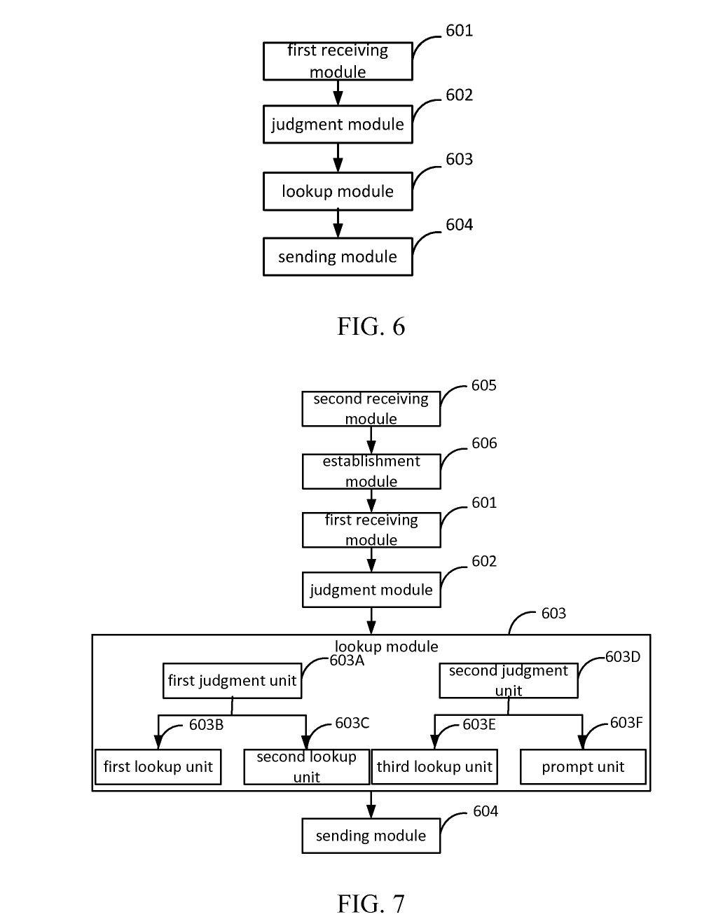

Refer to FIG. 6, this embodiment provides a server, including the following modules.

A first receiving module 601 is used to receive user information and identification info of software sent from a first mobile terminal when a user requests to install the software on the first mobile terminal.

A judgment module 602 is used to look up corresponding relationships between user information and software information established in advance, and judge if the corresponding relationships include the information of the user and the identification info of the corresponding software.

A lookup module 603 is used to determine that the user has backed up the software information when the judgment module 602 determines that the corresponding relationships include the information of the user and the identification info of the corresponding software and looks up a corresponding installation package according to the software.

A sending module 604 is used to send the installation package found by the lookup module 603 to the first mobile terminal, so that the first mobile terminal may install the software.

In this embodiment, the server also includes the following modules, which may refer to FIG. 7.

A second receiving module 605 is used to receive the information of the user and the identification info of the software when the user requests to back up the software.

An establishment module 606 is used to establish a corresponding relationship between the information of the user and the identification info of the software.

In the embodiment, the judgment module 602 is also used to judge if the corresponding relationships include a configuration file of the software corresponding to the information of the user.

The sending module 604 is also used to send the configuration file to the first mobile terminal when the judgment module 602 determines that the corresponding relationships include the configuration file of the software corresponding to the information of the user, so that the first mobile terminal may replace the configuration file generated in the installation process after the installation of the software.

In the embodiment, the first receiving module 601 is also used to receive the personalized information of the user sent from the first mobile terminal.

Accordingly, the lookup module 603 includes the following units.

A first judgment unit 603A is used to judge if the user chooses to install the latest version of the software according to the personalized information of the user.

A first lookup unit 603B is used to look up the installation package of the latest version corresponding to the identification info of the software when the first judgment unit 603A determines that the user chooses to install the latest version of the software.

A second lookup unit 603C is used to look up the version information of the software at backup corresponding to the information of the user found in the corresponding relationships when the first judgment unit 603A judges that the user chooses not to install the latest version of the software, and look up a corresponding installation package according to the version information found.

In this embodiment, the first receiving module 601 is also used to receive the personalized information of the user sent from the first mobile terminal and the operating system information of the first mobile terminal.

Accordingly, the lookup module 603 includes the following units.

A second judgment unit 603D is used to judge if the user chooses to accept a recommended installation package when there is no installation package matching the operating system of the first mobile terminal according to the personalized information of the user and the operating system information of the first mobile terminal.

A third lookup unit 603E is used to look up the installation package of other software matching the operating system of the first mobile terminal and relating to the software according to the identification info of the software and the operating system information of the first mobile terminal when the second judgment unit 603D judges that the user chooses to accept the recommended installation package when there is no installation package matching the operating system of the first mobile terminal.

A prompt unit 603F is used to prompt that there is no installation package of the software matching the operating system of the first mobile terminal and end the operation when the second judgment unit 603D judges that the user chooses not to accept the recommended installation package when there is no installation package matching the operating system of the first mobile terminal.

The server provided in this embodiment can execute software installation methods provided in the embodiments above. Refer to the descriptions in the embodiments for the detailed procedures.

With the server provided in the embodiment, when a user requests to install software on a mobile terminal, a server may receive user information and identification info of software sent from the mobile terminal, determines that the user has backed up the information of the software according to pre-established corresponding relationships of user information and software information, looks up installation packages corresponding to the identification info of the software, and sends them to the mobile terminal. The mobile terminal installs the software according to the installation packages. It saves the time and data traffic used in looking for installation software on one-by-one basis, improves the software installation efficiency, and reduces the risk associated with software installation of mobile terminals because the installation packages found are safe and virus free.

Further, the server sends a configuration file backed up in advance and the installation packages found to the mobile terminal, and the mobile terminal configures the software according to the configuration file to retain original using habits of the user, which may greatly improve user experience. Besides, software can be installed according to the personalized information of the user and in different situations according to different user settings. The technical solution has more flexible applications and strong practicability, and may improve user satisfaction.

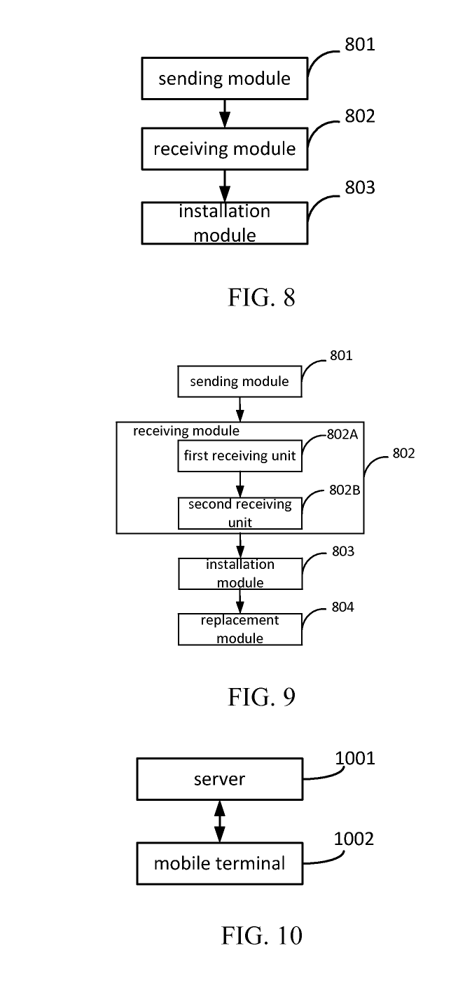

Refer to FIG. 8, this embodiment provides a mobile terminal including the following modules.

A sending module 801 is used to send user information and identification info of software to a server when a user requests software installation and allows the server to judge if pre-established corresponding relationships between user information and software information include the information of the user and the identification info of the software.

A receiving module 802 is used to receive an installation package sent from the server when the server determines that the user has backed up the information of the software and found the corresponding installation package according to the identification info of the software.

An installation module 803 is used to install the software according to the installation package received by the receiving module 802.

In this embodiment, refer to FIG. 9, the receiving module 802 is also used to receive the configuration file of the software corresponding to the information of the user sent by the server. The configuration file is backed up by the user and saved in the corresponding relationship by the server.

Accordingly, the mobile terminal also includes: a replacement module 804, which replaces the configuration file generated in the installation process with the configuration file received by the receiving module 802.

In this embodiment, the sending module 801 is also used to send the personalized information of the user to the server if the user has set up the personalized information on whether to install the latest version of the software.

Accordingly, the receiving module 802 includes the following units.

A first receiving unit 802A is used to receive the installation package of the latest version corresponding to the identification info of the software sent by the server when the server determines that the user chooses to install the latest version of the software according to the personalized information of the user.

A second receiving unit 802B is used to receive the corresponding installation package found according to the version information of the software at backup and sent by the server when the server determines that the user chooses to install the backup version of the software according to the personalized information of the user.

In the embodiment, the sending module 801 is also used to send the personalized information and local operating system information to the server if the user has set up the personalized information on whether to accept the recommended installation package when there is no installation package mating the local operating system.

Accordingly, the receiving module 802 is used to receive the installation package of other software sent by the server which matches the operating system and relates to the software, when the server determines according to the personalized information of the user and the operating system information that the user chooses to accept the recommended installation package when there is no installation package matching the operating system.

The server provided in this embodiment can execute any software installation method provided in any of the embodiments above. Refer to the descriptions in the embodiments for the detailed procedures.

With the mobile terminal provided by the embodiment, when a user requests to install software on a mobile terminal, a server receives the user information and the identification info of the software sent from the mobile terminal, determines that the user has backed up the information of the software according to the pre-established corresponding relationships of user information and software information, looks up installation packages corresponding to the identification info of the software, and sends them to the mobile terminal. The mobile terminal installs the software according to the installation packages. It saves the time and data traffic used in looking for installation software on one-by-one basis, improves the software installation efficiency, and reduces the risk associated with software installation of mobile terminals because the installation packages found are safe and virus free.

Further, the server sends a configuration file backed up in advance and the installation packages found to the mobile terminal, and the mobile terminal configures the software according to the configuration file to retain original using habits of the user, which may greatly improve user experience. Besides, software can be installed according to the personalized information of the user and in different situations according to different user settings. The technical solution has more flexible applications and strong practicability, and may improve user satisfaction.

Refer to FIG. 10, this embodiment provides a software installation system, including a server 1001 and a mobile terminal 1002.

The server 1001 can be a server provided in FIG. 6 or 7, and the mobile terminal 1002 can be a mobile terminal provided in FIG. 8 or 9.

The system provided in this embodiment can execute any software installation method provided in any of the embodiments above. Refer to the descriptions in the embodiments for the detailed procedures.

With the system provided in the embodiment, when a user requests to install software on a mobile terminal, a server receives the user information and the software identification info sent from the mobile terminal, determines that the user has backed up the information of the software according to the pre-established corresponding relationships of user information and software information, looks up installation packages corresponding to the identification info of the software, and sends them to the mobile terminal. The mobile terminal installs the software according to the installation packages. It saves the time and data traffic used in looking for installation software on one-by-one basis, improves the software installation efficiency, and reduces the risk associated with software installation of mobile terminals because the installation packages found are safe and virus free.

Further, the server sends a configuration file backed up in advance and the installation packages found to the mobile terminal, and the mobile terminal configures the software according to the configuration file to retain original using habits of the user to greatly improve user experience. Besides, software can be installed according to the personalized information of the user and in different situations according to different user settings. The technical solution may have more flexible application and strong practicability, and improve user satisfaction.

It should be noted that when the device or system provided in the above embodiments installs software, division of functional modules described above may be used as an example. In actual applications, the above functions can be distributed to different functional modules according to requirements. That is, the internal structure of the device may be divided into different functional modules to fulfill all or part of the functions above. Besides, the server, the mobile terminal, the software installation system, and the method provided in the above embodiments are of the same conception. The method embodiments may be referred to for detailed implementations. No detailed description will be given here repeatedly.

The serial numbers of embodiments are for description purpose only and do not imply the advantages and disadvantages of the embodiments.

All or part of the embodiments can be realized through software, and corresponding software programs can be stored in readable storage media, e.g., a compact disc or a hard disk.

The preferred embodiments described above are all exemplary in nature only and should not be construed as restrictions to the present invention in any way. Any modifications, variations, equivalent replacements and improvements, which are apparent to those skilled in the art without departing from the scope and spirit of the present invention, are intended to be within the scope of the following claims.

1. A software installation method, comprising:
when a user requests software installation on a first mobile terminal, receiving information of the user and identification info of the software sent from the first mobile terminal;
looking up corresponding relationships between user information and software information established in advance, and judging whether the corresponding relationships include the information of the user and the identification info of the corresponding software; and
if yes, confirming that the user has backed up the software information, looking up an installation package corresponding to the identification info of the software, and sending the installation package found to the first mobile terminal for installation of the software.

2. The method according to claim 1, further comprising:
before receiving the information of the user and the identification info of the software sent from the first mobile terminal, when the user requests to back up the software, receiving the user information and the identification info of the software; and
establishing a corresponding relationship between the user information and the identification info of the software.

3. The method according to claim 1, wherein judging whether the corresponding relationships include the information of the user and the identification info of the corresponding software further comprises:
judging whether the corresponding relationships include the information of the user and a configuration file of the corresponding software; and
if yes, sending the configuration file to the first mobile terminal, wherein the configuration file is used to replace a configuration file generated during the installation of the software on the first mobile terminal.

4. The method according to claim 1, wherein receiving the information of the user and the identification info of the software sent from the first mobile terminal further comprises: receiving personalized information of the user sent from the first mobile terminal; and
looking up the installation package corresponding to the identification info of the software comprises:
judging whether the user chooses to install a latest version of the software according to the personalized information of the user;
if yes, looking up the corresponding installation package of the latest version according to the personalized information of the user;
otherwise, looking up version information of a backup of the software corresponding to the information of the user stored in the corresponding relationship, and finding a corresponding installation package according to the version information found.

5. The method according to claim 1, wherein receiving the information of the user and the identification info of the software sent from the first mobile terminal further comprises: receiving personalized information of the user and information of an operating system of the first mobile terminal sent from the first mobile terminal; and
looking up an installation package corresponding to the identification info of the software comprises:
according to the personalized information of the user and the information of the operating system of the first mobile terminal, judging whether the user chooses to accept a recommended installation package when there is no installation package matching the operating system of the first mobile terminal;
if yes, looking up an installation package of other software relating to the software that matches the operating system of the first mobile terminal;
otherwise, prompting no installation package of the software matching the operating system of the first mobile terminal.

6. A software installation method, comprising:
when a user requests software installation, sending information of the user and identification info of the software to a server, wherein the information of the user and the identification info of the software are used by the server to judge whether the information of the user and the identification info of the corresponding software exist in corresponding relationships between user information and software information established in advance;
when the server confirms that the user has backed up the software information and finds an installation package according to the identification info of the software, receiving the installation package sent by the server; and
installing the software according to the installation package received.

7. The method according to claim 6, wherein receiving the installation package sent by the server further comprises: receiving a configuration file of the software corresponding to the information of the user sent by the user, wherein the configuration file is backed up by the user and saved in the corresponding relationships by the server; and
installing the software according to the installation package received further comprises: replacing a configuration file generated during the installation with the configuration file received.

8. The method according to claim 6, wherein sending the information of the user and the identification info of the software further comprises: if the user sets personalized information concerning whether to install a latest version of the software, sending the personalized information of the user to the server; and
receiving the installation package sent by the server comprises:
when the server determines that the user selects to install the software with the latest version according to the personalized information of the user, receiving the installation package of the latest version corresponding to the identification info of the software sent by the server; and
when the server determines that the user selects to install the software with a backup version according to the personalized information of the user, finding out an installation package according to version information at backup of the software corresponding to the information of the user sent by the server.

9. The method according to claim 6, wherein sending the information of the user and the identification info of the software to the server further comprises:
if the user sets personalized information concerning whether to accept a recommended installation package when there is no installation package matching a local operating system, sending the personalized information of the user and information of the local operating system to the server; and
receiving the installation package sent by the server comprises:
when the sever determines, according to the personalized information of the user and the information of the local operating system, that the user chooses to accept the recommended installation package when there is no installation package matching the operating system, accepting an installation package of other software sent by the server related to the software and matching the operating system.

10. A server, comprising:
a first receiving module, configured to receive information of a user and identification info of software sent from a first mobile terminal when the user requests to install the software on the first mobile terminal;
a judgment module, configured to look up corresponding relationships between user information and software information established in advance, and judge whether the corresponding relationships include the information of the user and the identification info of the corresponding software;
a lookup module, configured to determine that the user has backed up the software information when the judgment module determines that the corresponding relationships include the information of the user and the identification info of the corresponding software, and look up an installation package corresponding to the software; and
a sending module, configured to send the installation package found by the lookup module to the first mobile terminal, wherein the installation package is configured to install the software on the first mobile terminal.

11. The server according to claim 10, further comprising:
a second receiving module, configured to receive the information of the user and the identification info of the software when the user requests to back up the software; and
an establishment module, configured to establish a corresponding relationship between the information of the user and the identification info of the software.

12. The server according to claim 10, wherein the judgment module is further configured to judge whether the corresponding relationships include a configuration file of the software corresponding to the information of the user; and
the sending module is further configured to send the configuration file to the first mobile terminal when the judgment module determines that the corresponding relationships include the configuration file of the software corresponding to the information of the user, wherein the configuration file is used to replace a configuration file generated during the installation after the software is installed on the first mobile terminal.

13. The server according to claim 10, wherein the first receiving module is further configured to receive personalized information of the user sent from the first mobile terminal; and
the lookup module comprises:
a first judgment unit, configured to judge whether the user chooses to install a latest version of the software according to the personalized information of the user;
a first lookup unit, configured to look up the installation package with the latest version corresponding to the identification info of the software when the first judgment unit determines that the user chooses to install the latest version of the software; and
a second lookup unit, configured to look up version information of the software at backup corresponding to the information of the user within the corresponding relationships when the first judgment unit determines that the user chooses not to install the latest version of the software, and look up an installation package corresponding to the version information found.

14. The server according to claim 10, wherein the first receiving module is further configured to receive the personalized information of the user sent from the first mobile terminal and information of the operating system of the first mobile terminal; and
the lookup module comprises:
a second judgment unit, configured to judge whether the user chooses to accept the recommended installation package when there is no installation package matching the operating system of the first mobile terminal according to the personalized information of the user and the information of the operating system of the first mobile terminal;
a third lookup unit, configured to look up an installation package of other software matching the operating system of the first mobile terminal and relating to the software according to the identification info of the software and the information of the operating system of the first mobile terminal when the second judgment unit determines that the user chooses to accept the recommended installation package when there is no installation package matching the operating system of the first mobile terminal; and
a prompt unit, configured to prompt that there is no installation package of the software matching the operating system of the first mobile terminal when the second judgment unit determines that the user chooses not to accept the recommended installation package when there is no installation package matching the operating system of the first mobile terminal.

15. A mobile terminal, comprising:
a sending module, configured to send information of a user and identification info of software to a server when the user requests to install the software, wherein the server judges whether pre-established corresponding relationships between user information and software information include the information of the user and the identification info of the software;
a receiving module, configured to receive an installation package sent from the server when the server determines that the user has backed up the information of the software and found corresponding installation package according to the identification info of the software; and
an installation module, configured to install the software according to the installation package received by the receiving module.

16. The mobile terminal according to claim 15, wherein the receiving module is further configured to receive a configuration file of the software corresponding to the information of the user sent by the server, wherein the configuration file is backed up by the user and saved in the corresponding relationships by the server;
the mobile terminal further comprises: a replacement module, configured to replace a configuration file generated in the installation process with the configuration file received by the receiving module; and
the sending module is further configured to send personalized information of the user to the server if the user has set up the personalized information concerning whether to install the latest version of the software.

17. The mobile terminal according to claim 15, wherein the sending module is further configured to send the personalized information of the user to the server if the user has set up the personalized information concerning whether to install the latest version of the software; and
the receiving module comprises:
a first receiving unit, configured to receive the installation package of the latest version corresponding to the identification info of the software sent by the server when the server determines that the user chooses to install the latest version of the software according to the personalized information of the user;
a second receiving unit, configured to receive the corresponding installation package found according to version information of the software at backup sent by the server when the server determines that the user chooses to install the backup version of the software according to the personalized information of the user.

18. The mobile terminal according to claim 15, wherein the sending module is further configured to send the personalized information and information of the local operating system to the server if the user has set up the personalized information concerning whether to accept the recommended installation package when there is no installation package matching the local operating system; and
the receiving module is configured to receive the installation package of other software related to the software that is sent by the server and matches the operating system when the server determines according to the personalized information of the user and the information of the operating system that the user chooses to accept the recommended installation package when there is no installation package matching the operating system.
